(19) United States
(12) Patent Application Publication
(10) Pub. No.: US 2014/0125548 A1
(43) Pub. Date: May 8, 2014

(54) Apparatus With A Near Field Coupling Member And Method For Communication

(71) Applicants: Cyril Jouanlanne, Valby (DK); Rune Soe, Copenhagen (DK)

(72) Inventors: Cyril Jouanlanne, Valby (DK); Rune Soe, Copenhagen (DK)

(73) Assignee: Nokia Corporation, Espoo (FI)

(21) Appl. No.: 14/006,964

(22) PCT Filed: Mar. 24, 2011
(86) PCT No.: PCT/FI2011/050245

§ 371 Date: Dec. 9, 2013

(51) Int. Cl. H01Q 7/04

(52) U.S. Cl. CPC H01Q 7/04
USPC 343/867; 29/600

(57) ABSTRACT

An apparatus comprising: a ground member (22) including an edge (32); a near field coupling member (30) configured to electromagnetically couple with other coupling members (41) external to the apparatus (12), and being configured to receive signals from and/or provide signals to radio frequency circuitry (14), at least a first portion (44) of the one or more loops being positioned adjacent or at the edge (32) of the ground member, the near field coupling member (30) including one or more loops defining an aperture (42), the near field coupling member being configured to receive one or more antennas (18) within the aperture (42) of the one or more loops. The first portion (44) of the one or more loops may be positioned outside of the edge of the ground member and be separated from the edge by a first gap (46). The apparatus may further comprise one or more decoupling members (48) configured to reduce interference between the near field coupling member and the one or more antennas (18).

### TECHNOLOGICAL FIELD

Embodiments of the present invention relate to an apparatus and method for wireless communication. In particular, they relate to an apparatus in an electronic device.

### BACKGROUND

Apparatus, such as mobile cellular telephones, usually include one or more antennas that enable the apparatus to communicate wirelessly. One of the antennas may be a near field coupling member (such as a radio frequency identification (RFID) antenna) that enables information to be wirelessly transmitted to, and/or received from, another near field coupling member (a radio frequency identification tag or reader for example) that is external to the apparatus.

In current apparatus, the near field coupling member may occupy a relatively large space in the apparatus. This may result in the apparatus being undesirably large, or may result in the apparatus having fewer electronic components in order to compensate for the space occupied by the near field coupling member.

Therefore, it would be desirable to provide an alternative apparatus.

### BRIEF SUMMARY

According to various, but not necessarily all, embodiments of the invention there is provided an apparatus comprising: a ground member including an edge; a near field coupling member configured to electromagnetically couple with other coupling members external to the apparatus, and being configured to receive signals from and/or provide signals to radio frequency circuitry, the near field coupling member including one or more loops defining an aperture and at least a first portion of the one or more loops being positioned adjacent or at the edge of the ground member, the near field coupling member being configured to receive one or more antennas within the aperture of the one or more loops.

The apparatus may be for wireless communication.

The first portion of the one or more loops may be positioned outside of the edge of the ground member and may be separated from the edge by a first gap.

The apparatus may further comprise one or more decoupling members configured to reduce interference between the near field coupling member and the one or more antennas.

The near field coupling member may be configured to operate in a first frequency band and the one or more antennas may be configured to operate in at least a second frequency band.

The one or more decoupling members may include one or more reactive components connected between the near field coupling member and the ground member, the one or more reactive components having an impedance at the first frequency band greater than the impedance at the second frequency band.

A second portion of the one or more loops may overlay the ground member and include a part separated from the ground member by a second gap, the second gap being selected to form a capacitor with the ground member having an impedance at the first frequency band greater than the impedance at the second frequency band

The one or more decoupling members may include ferrous material positioned between the near field coupling member and one or more of: the ground member and the one or more antennas.

No ferrous material may be provided between the near field coupling member and the ground member.

The near field coupling member may be non-planar.

The first portion of the one or more loops may be integral with the ground member.

According to various, but not necessarily all, embodiments of the invention there is provided a module comprising an apparatus as described in any of the preceding paragraphs.

According to various, but not necessarily all, embodiments of the invention there is provided an electronic device comprising an apparatus as described in any of the preceding paragraphs.

According to various, but not necessarily all, embodiments of the invention there is provided a method comprising: providing a ground member including an edge; and providing a near field coupling member configured to electromagnetically couple with other coupling members external to the apparatus, and being configured to receive signals from and/or provide signals to radio frequency circuitry, the near field coupling member including one or more loops defining an aperture and at least a first portion of the one or more loops being positioned adjacent or at the edge of the ground member, the near field coupling member being configured to receive one or more antennas within the aperture of the one or more loops.

The first portion of the one or more loops may be positioned outside of the edge of the ground member and may be separated from the edge by a first gap.

The method may further comprise providing one or more decoupling members configured to reduce interference between the near field coupling member and the one or more antennas.

The near field coupling member may be configured to operate in a first frequency band and the one or more antennas may be configured to operate in at least a second frequency band,

The one or more decoupling members may include one or more reactive components connected between the near field coupling member and the ground member, the one or more reactive components having an impedance at the first frequency band greater than the impedance at the second frequency band.

A second portion of the one or more loops may overlay the ground member and include a part separated from the ground member by a second gap, the second gap being selected to form a capacitor with the ground member having an impedance at the first frequency band greater than the impedance at the second frequency band.

The one or more decoupling members may include ferrous material positioned between the near field coupling member and one or more of: the ground member and the one or more antennas.

No ferrous material may be provided between the near field coupling member and the ground member.

The near field coupling member may be non-planar.

The first portion of the one or more loops may be integral with the ground member.

### BRIEF DESCRIPTION

For a better understanding of various examples of embodiments of the present invention reference will now be made by way of example only to the accompanying drawings in which:

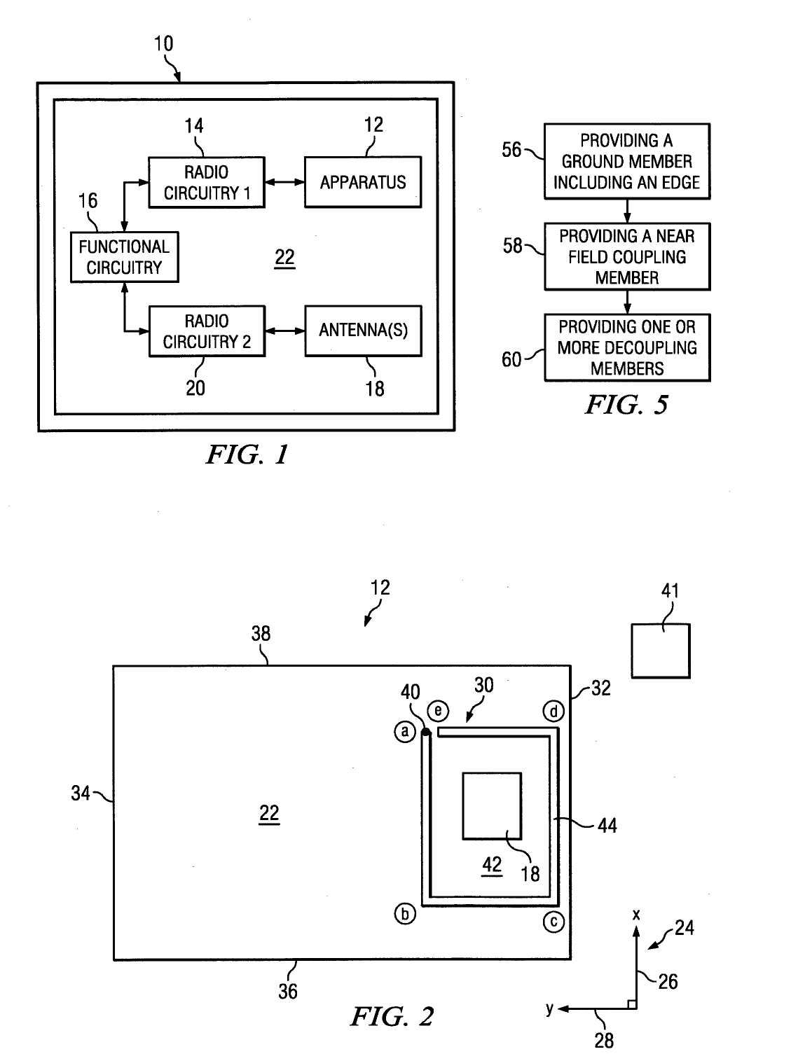

FIG. 1 illustrates a schematic diagram of an electronic device including an apparatus according to various embodiments of the invention;

FIG. 2 illustrates a schematic diagram of an apparatus according to various embodiments of the invention;

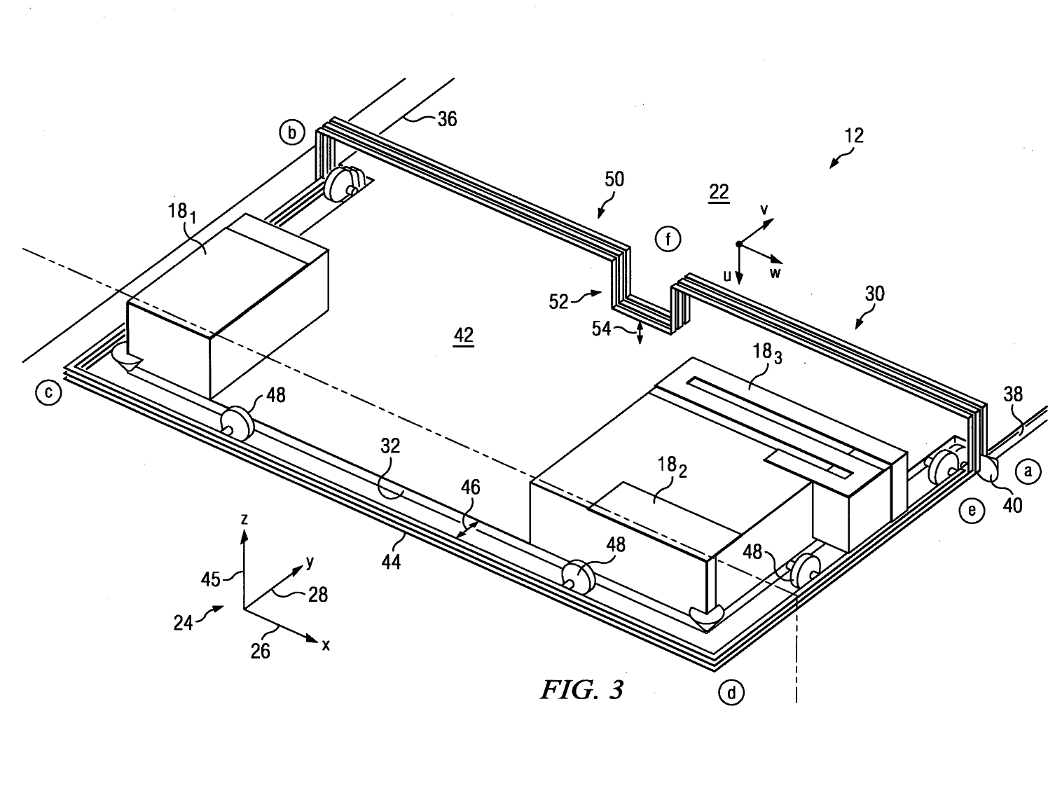

FIG. 3 illustrates a perspective view of another apparatus according to various embodiments of the invention;

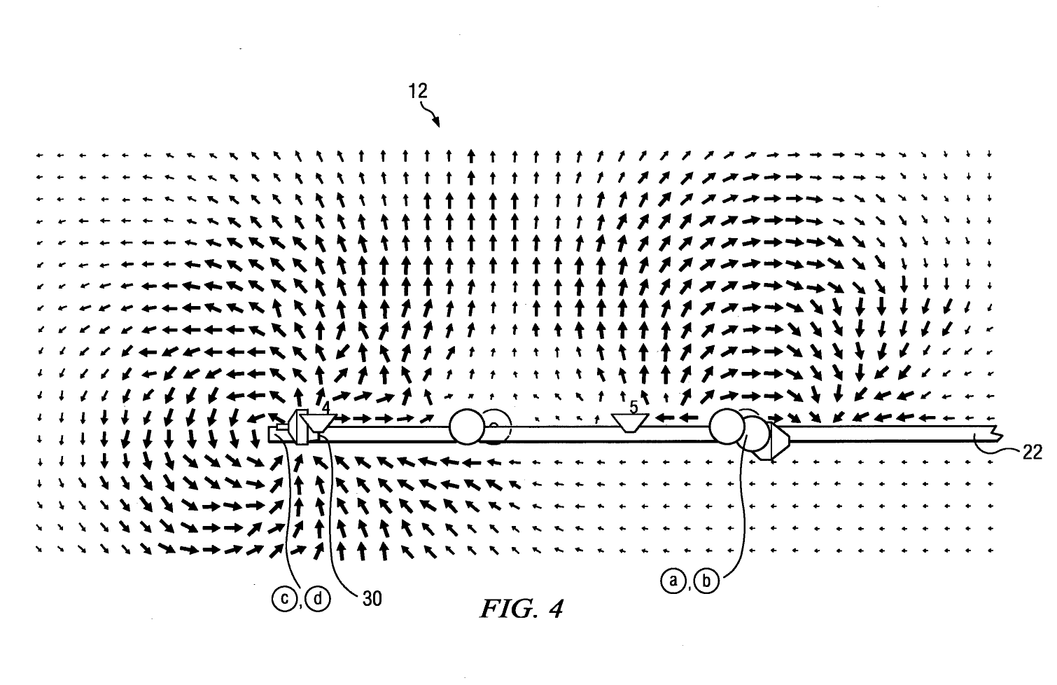

FIG. 4 illustrates a side view of the magnetic field of the apparatus illustrated in FIG. 3; and

FIG. 5 illustrates a flow diagram of a method according to various embodiments of the invention.

### DETAILED DESCRIPTION

In the following description, the wording ‘connect’ and ‘couple’ and their derivatives mean operationally connected or coupled. It should be appreciated that any number or combination of intervening components can exist (including no intervening components). Additionally, it should be appreciated that the connection or coupling may be a physical galvanic connection and/or an electromagnetic connection.

FIGS. 2 and 3 illustrate an apparatus 12 comprising: a ground member 22 including an edge 32; a near field coupling member 30 configured to electromagnetically couple with other coupling members 41 external to the apparatus 12, and being configured to receive signals from and/or provide signals to radio frequency circuitry 14, the near field coupling member 30 including one or more loops defining an aperture 42 and at least a first portion 44 of the one or more loops being positioned adjacent or at the edge 32 of the ground member 22, the near field coupling member 30 being configured to receive one or more antennas 18 within the aperture 42 of the one or more loops.

In more detail, FIG. 1 illustrates an electronic communication device 10 according to various embodiments of the invention. The electronic communication device 10 may be any apparatus and may be a portable communication device (for example, a mobile cellular telephone, a tablet computer, a laptop computer, a personal digital assistant or a hand held computer), or a module for such devices. As used here, ‘module’ refers to a unit or apparatus that excludes certain parts or components that would be added by an end manufacturer or a user.

The electronic communication device 10 comprises an apparatus 12, first radio circuitry 14, functional circuitry 16, one or more antennas 18, second radio circuitry 20 and a ground member 22. The apparatus 12 may also be referred to as an antenna arrangement and is configured to transmit and receive electromagnetic signals in the near field.

The first radio circuitry 14 is connected between the apparatus 12 and the functional circuitry 16 and may include a receiver and a transmitter. The functional circuitry 16 is operable to provide signals to, and receive signals from the first radio circuitry 14. The electronic communication device 10 may include one or more matching circuits between the apparatus 12 and the first radio circuitry 14.

The apparatus 12 and the first radio circuitry 14 may be configured to operate in one or more operational frequency bands and via one or more protocols. For example, the operational frequency bands and protocols may include (but are not limited to) radio frequency identification low frequency (RFID LF) (0.125-0.134 MHz); radio frequency identification high frequency (RFID HF) (13.56 MHz). The apparatus 12 and the radio circuitry 14 may be configured to operate using Near Field communication (NFC) (13.56 MHz) and may thus be able to communicate with other devices according to the proximity card standard ISO/IEC 14443. A frequency band over which the apparatus 12 can efficiently operate using a protocol is a frequency range where the return loss of the apparatus 12 and one or more matching circuits is greater than an operational threshold. For example, efficient operation may occur when the return loss of the apparatus 12 and one or more matching circuits is better than −6 dB or −10 dB.

The one or more antennas 18 may include any suitable antennas and may include, for example, planar inverted F antennas (PIFA's), planar inverted L antennas (PILA's), monopole antennas, loop antennas and whip antennas. The one or more antennas 18 may be configured to transmit and receive, transmit only or receive only electromagnetic signals.

The second radio circuitry 20 is connected between the one or more antennas 18 and the functional circuitry 16 and may include a receiver and/or a transmitter. The functional circuitry 16 is operable to provide signals to, and/or receive signals from the second radio circuitry 20. The electronic communication device 10 may include one or more matching circuits between the one or more antennas 18 and the second radio circuitry 20. In various embodiments, the electronic device 10 may include a single transceiver that is configured to function as the first radio circuitry 14 and the second radio circuitry 20.

The one or more antennas 18 and the second radio circuitry 20 may be configured to operate in a plurality of different operational frequency bands and via a plurality of different protocols. For example, the different operational frequency bands and protocols may include (but are not limited to) Long Term Evolution (LTE) 700 (US) (698.0-716.0 MHz, 728.0-746.0 MHz), LTE 1500 (Japan) (1427.9-1452.9 MHz, 1475.9-1500.9 MHz), LTE 2600 (Europe) (2500-2570 MHz, 2620-2690 MHz), amplitude modulation (AM) radio (0.535-1.705 MHz); frequency modulation (FM) radio (76-108 MHz); Bluetooth (2400-2483.5 MHz); wireless local area network (WLAN) (2400-2483.5 MHz); hyper local area network (HLAN) (5150-5850 MHz); global positioning system (GPS) (1570.42-1580.42 MHz); US Global system for mobile communications (US-GSM) 850 (824-894 MHz) and 1900 (1850-1990 MHz); European global system for mobile communications (EGSM) 900 (880-960 MHz) and 1800 (1710-1880 MHz); European wideband code division multiple access (EU-WCDMA) 900 (880-960 MHz); personal communications network (PCN/DCS) 1800 (1710-1880 MHz); US wideband code division multiple access (US-WCDMA) 1700 (transmit: 1710 to 1755 MHz, receive: 2110 to 2155 MHz) and 1900 (1850-1990 MHz); wideband code division multiple access (WCDMA) 2100 (transmit: 1920-1980 MHz, receive: 2110-2180 MHz); personal communications service (PCS) 1900 (1850-1990 MHz); ultra wideband (UWB) Lower (3100-4900 MHz); UWB Upper (6000-10600 MHz); digital video broadcasting-handheld (DVB-H) (470-702 MHz); DVB-H US (1670-1675 MHz); digital radio mondiale (DRM) (0.15-30 MHz); worldwide interoperability for microwave access (WiMax) (2300-2400 MHz, 2305-2360 MHz, 2496-2690 MHz, 3300-3400 MHz, 3400-3800 MHz, 5250-5875 MHz); digital audio broadcasting (DAB) (174.928-239.2 MHz, 1452.96-1490.62 MHz). A frequency band over which the one or more antennas 18 can efficiently operate using a protocol is a frequency range where the return loss of the one or more antennas 18 is greater than an operational threshold. For example, efficient operation may occur when the antenna's return loss is better than −6 dB or −10 dB.

In the embodiment where the electronic device 10 is a portable communication device, the functional circuitry 16 may include a processor, a memory and input/output devices such as an audio input device (a microphone for example), an audio output device (a loudspeaker for example), a user input device (a touch screen display, a keypad or a keyboard for example) and a display. The apparatus 12, the electronic components that provide the first and second radio circuitry 14, 20, the functional circuitry 16 and the one or more antennas 18 may be interconnected via the ground member 22 (for example, a printed wiring board). The ground member 22 may be used as a ground plane for the apparatus 12 and the one or more antennas 18 by using one or more layers of the printed wiring board. In other embodiments, some other conductive part of the electronic communication device 10 (a battery cover for example) may be used as the ground member 22 for the apparatus 12 and the one or more antennas 18. The ground member 22 may be formed from several conductive parts of the electronic device 10, for example and not limited to the printed wiring board, a conductive battery cover, and/or at least a portion of a cover of the electronic communication device 10. It should be appreciated that the ground member 22 may be planar or non-planar.

FIG. 2 illustrates a schematic diagram of an apparatus 12 according to various embodiments of the invention. FIG. 2 is similar to FIG. 1 and where the features are similar, the same reference numerals are used. FIG. 2 also illustrates a Cartesian co-ordinate axis 24 which includes an X axis 26 and a Y axis 28 that are orthogonal to one another.

The apparatus 12 includes a ground member 22 and a near field coupling member 30. The ground member 22 is substantially rectangular and is oriented parallel to the X-Y plane. The ground member 22 includes a first edge 32, a second edge 34, a third edge 36 and a fourth edge 38. The first edge 32 and the second edge 34 are shorter than the third edge 36 and the fourth edge 38. The first edge 32 and the second edge 34 are oriented parallel to the X axis 26 and the third edge 36 and the fourth edge 38 are oriented parallel to the Y axis 28. It should be appreciated that the ground member 22 may have other shapes and may be, for example, square, circular or elliptical.

The near field coupling member 30 may comprise any suitable conductive material and may comprise copper for example. The near field coupling member 30 is positioned at the end of the ground member 22 defined by the first edge 32 and is connected to the first radio frequency circuitry 14 via one or more feed points 40 and may consequently receive signals from, and transmit signals to the first radio frequency circuitry 14. In at least some embodiments, the near field coupling member 30 may also be referred to as an antenna or an inductive element.

The near field coupling member 30 has an electrical length that results in an inductance that is matched with a matching circuit (not illustrated in the figures). Consequently, the near field coupling member 30 may electromagnetically couple with other coupling members 41 in the near field (for example, within ten centimeters of the near field coupling member 30) and external to the apparatus 12 and the electronic communication device 10. It should be appreciated that the combination of the near field coupling member 30 and another coupling member 41 transfer information via electromagnetic induction and may be considered to be similar to a pair of inductively coupled transformer windings. In at least some embodiments, the near field coupling member 30 is configured so that it is unable to operate effectively in the ‘far field’.

The near field coupling member 30 may include one or more loops which define an aperture 42 therein. It should be appreciated that the near field coupling member 42 may include any number of loops in order to obtain a desired electrical length and desired dimensions. More specifically, the area of the near field coupling member 30 is important for providing an adequate magnetic field (H-field) strength (Amperes/meter or Nm), thus the area must be a minimum size in order for the near field coupling member 30 to achieve a predetermined H-field strength, for example 1.5 A/m. The number of loops will also determine the inductance of the near field coupling member 30. A further parameter is that of the Quality (Q) value of the near field coupling member 30 which must be within a certain range so that the correct waveshape of the RFID signal is achieved (higher limit of Q-value) and so that energy is not wasted (lower limit of Q-value). The Q-value, for example, could be 35+/−5.

In more detail, the first end of the near field coupling member 30 extends from the feed point 40 at position (a) in the −X direction until position (b). At position (b), the near field coupling member 30 forms a right angled bend and then extends in the −Y direction until position (c). At position (c), the near field coupling member 30 forms a right angled bend and then extends in the +X direction until position (d). At position (d), the near field coupling member 30 forms a right angled bend and extends in the +Y direction until position (e) at which the second end of the near field coupling member 30 is located. It should be appreciated from FIG. 2 that the first end and the second end of the near field coupling member 30 are positioned adjacent one another and that the loop is approximately square/rectangular in shape. In other embodiments, the one or more loops of the near field coupling member 30 may have any other suitable shape and may have bends that are more or less than ninety degrees and may be curved.

The near field coupling member 30 is positioned adjacent the first edge 32 of the ground member 22 between positions (c) and (d) and this portion of the near field coupling member 30 shall hereinafter be referred to as the first portion 44. The first portion 44 may be positioned within the first edge 32 and therefore overlay the ground member 22 (as illustrated in FIG. 2), or may be positioned at the first edge 32 and therefore overlay the first edge 32, or may be positioned outside of the first edge 32 so that the first portion 44 does not overlay the ground member 22. The positioning of the first portion 44 of the near field coupling member 30 adjacent or at the first edge 32 may provide an advantage in that the magnetic field (H-field) of the near field coupling member 30 may be relatively strong adjacent the first edge 32 (in comparison to an apparatus where a near field coupling member is not positioned adjacent an edge of the ground plane). This may help to maximize the distance over which the apparatus 12 may electromagnetically couple with other coupling members external to the apparatus 12.

In various embodiments, at least the first portion 44 of the near field coupling member 30 is integral with the ground member 22 (that is, they are formed from the same piece of material and have not been joined together). For example, where the ground member 22 is a printed wiring board, the near field coupling member 30 may be formed from one or more conductive layers of the printed wiring board and the first portion 44 of the near field coupling member 30 may correspond to a perimeter of the ground member 22. In other embodiments, the near field coupling member 30 may be separate to the ground member 22 and either the whole near field coupling member 30 or only one or more parts of the whole near field coupling member 30 may be mounted on the ground member 22 via a carrier for example.

The near field coupling member 30 is configured to receive one or more antennas 18 within the aperture 42 defined by the one or more loops. In more detail, the one or more loops of the near field coupling member 30 are shaped and dimensioned so that the aperture 42 may receive one or more antennas 18 therein (that is, the one or more antennas 18 may lay within the inner perimeter of the one or more loops). Consequently, the one or more loops are able to lie in the same plane as the one or more antennas 18 and wholly surround them.

The apparatus 12 may provide an advantage in that since one or more other antennas 18 may be positioned within the aperture 42, the inclusion of the near field coupling member 30 in an electronic device may not require any additional significant volume to be allocated to the apparatus 12. Consequently, the apparatus 12 may not require an electronic device to be designed specially to accommodate the apparatus 12. Furthermore, the apparatus 12 may not occupy a significant volume in an electronic device and this may advantageously result in a relatively small electronic device or may result in additional space for other components of the electronic device.

FIG. 3 illustrates a perspective view of another apparatus 12 according to various embodiments of the invention. The apparatus 12 illustrated in FIG. 3 is similar to the apparatus illustrated in FIG. 2, and where the features are similar, the same reference numerals are used. FIG. 3 also illustrates the Cartesian coordinate system 24 which includes the X axis 26, the Y axis 28 and a Z axis 45 which are orthogonal to one another.

The near field coupling member 30 illustrated in FIG. 3 differs from the near field coupling member illustrated in FIG. 2 in that at position (a), the near field coupling member 30 first extends from the feed point 40 in the +Z direction and then extends in the −X direction. Additionally, at position (b) the near field coupling member 30 first extends in the −Z direction and then in the −Y direction.

At a position (f) which is substantially half way between position (a) and position (b), the near field coupling member 30 forms a U shape that extends towards the ground member 22. In more detail, the near field coupling member 30 forms a right angled bend and extends in the −Z direction, then forms another right angled bend and extends in the −X direction, then forms another right angled bend and extends in the +Z direction and then forms another right angled bend and extends in the −X direction until position (b). Furthermore, the near field coupling member 30 includes three loops which are connected in series and are arranged concentrically so that they share a common centre point (that is, they may be considered as windings around a common centre).

From the preceding paragraph, it should be appreciated that the near field coupling member 30 is non-planar since it extends in the X axis 26, the Y axis 28 and the Z axis 45. In other embodiments, the near field coupling member 30 may be planar.

In this embodiment, a first antenna 18₁, a second antenna 18₂, and a third antenna 18₃ are positioned within the aperture 42 defined by the near field coupling member 30. The first antenna 18₁ is positioned at the corner of the ground member 22 that is defined by the first edge 32 and the third edge 36 and is configured to function as a cellular receive diversity antenna. The second antenna 18₂ is positioned at the corner of the ground member 22 that is defined by the first edge 32 and the fourth edge 38 and is configured to function as a Bluetooth (BT) and wireless local area network antenna (WLAN). The third antenna 18₃ is positioned adjacent the second antenna 18₂ along the fourth edge 38 and is configured to function as a global positioning system (GPS) antenna.

The near field coupling member 30 is configured to operate in a first operational frequency band and the antennas 18 are configured to operate in at least a second operational frequency band. For example, the near field coupling member 30 may be configured to operate at the radio frequency identification high frequency (RFID HF) band (13.56 MHz), whereas the second antenna 18₂, for example, may be configured to operate at the Bluetooth band (2400-2483.5 MHz).

The first portion 44 is positioned outside of the first edge 32 of the ground member 22 and is separated from the first edge 32 by a first gap 46. Additionally, the portion of the near field coupling member 30 between positions (b) and (c), and the portion of the near field coupling member 30 between positions (d) and (e) are also positioned outside of the third and fourth edges 36, 38 respectively and are separated from the edges 36, 38 by the first gap. It should be appreciated that the sizes of the gaps between the near field coupling member 30 and the edges 32, 36, 38 may be the same or may be different to one another. Consequently, the first portion 44 and the portions between (b) and (c) and between (d) and (e) do not overlay the ground member 22 when viewed in plan. This arrangement may be advantageous in that the spacing of the near field coupling member 30 from the ground member 22 and the antennas 18 may help to reduce electromagnetic coupling between them and therefore increase the operating efficiency of the near field coupling member 30 and the antennas 18.

The apparatus 12 additionally includes one or more decoupling members 48 which are configured to reduce electromagnetic interference between the near field coupling member 30 and the antennas 18. In various embodiments, the decoupling members 48 include one or more reactive components which are connected between the near field coupling member 30 and the ground member 22. For example, the reactive components may include capacitors and/or inductors that are connected between the near field coupling member 30 and the first, third and fourth edges 32, 36, and 38 of the ground member 22.

The reactive components are configured to have an impedance at the first operational frequency band that is greater than the impedance at the second operational frequency band. For example, the impedance of the reactive components at the first operational frequency band (that is, the operating frequency band of the near field coupling member 30) may be of the order of several hundred or several thousands of ohms, whereas the impedance of the reactive components at the second operational frequency band (that is, the operating frequency band of an antenna 18) may be of the order of one to ten ohms. Since the impedance of the reactive components is relatively low at the second operational frequency band, electrical signals in the second operational frequency band which are induced in the near field coupling member 30 by an antenna 18 flow to the ground member 22, thus reducing interference between the near field coupling member 30 and one or more of the antennas 18.

It should be appreciated that the reactive components may have different reactances to one another and may consequently be configured to have relatively low impedances at different frequency bands. For example, a first reactive component may have a low or minimum impedance at the operating frequency band of the first antenna 18₁, a second reactive component may have a low or minimum impedance at the operating frequency band of the second antenna 18₂ and a third reactive component may have a low or minimum impedance at the operating frequency band of the third antenna 18₃. Therefore, the reactive components may be configured to reduce interference with a plurality of antennas operating at different operational frequency bands.

The portion of the near field coupling member 30 between positions (a) and (b) shall hereinafter be referred to as the second portion 50. The second portion 50 overlays the ground member 22 and includes a part 52 at position (f) which is separated from the ground member 22 by a second gap 54. The second gap 54 is selected in dimensions to form a capacitor with the ground member 22 that has an impedance at the first operational frequency band which is greater than the impedance at the second operational frequency band. Consequently, the part 52 forms a decoupling member as described in the preceding paragraphs which may help to reduce interference between the near field coupling member 30 and one or more of the antennas 18.

In other embodiments, a decoupling capacitor may be additionally or alternatively formed by the ground member 22 including a protrusion (which may be viewed as a small tower) extending in the +Z direction and positioned underneath the second portion 50 of the near field coupling member 30. In these embodiments, the near field coupling member 30 may not form a U shape in the second portion 50.

Various embodiments of the invention provide an advantage in that the decoupling members 48 and 52 may reduce electromagnetic interference between the near field coupling member 30 and the antennas 18 to an extent that no or little ferrous material is required between the near field coupling member 30 and the ground member 22. Since ferrous material is relatively expensive, the absence or reduction of ferrous material in the apparatus 12 may advantageously reduce the cost of the apparatus 12.

In some embodiments, the one or more decoupling members 48 may include ferrous material positioned between the near field coupling member 30 and the ground member 22 and/or the one or more of the antennas 18 to reduce electromagnetic interference. For example, ferrous material may be provided between the near field coupling member 30 and the ground member 22 between positions (a) and (b). By way of another example, ferrous material may be provided between the near field coupling member 30 and the third antenna 18₃.

FIG. 4 illustrates a side view of the apparatus 12 illustrated in FIG. 3 and the magnetic field of the near field coupling member 30. Viewing along the near field coupling member 30 at positions (a) and (b), the magnetic field is represented by arrows which are arranged in concentric circles and that are oriented clockwise. Viewing along the near field coupling member 30 at positions (c) and (d), the magnetic field is represented by arrows which are arranged in concentric circles and that are oriented anti-clockwise.

It should be appreciated from FIG. 4 that the magnetic field is relatively strong adjacent the first edge 32 of the ground member 22 and the apparatus 12 may efficiently inductively couple with other coupling members (not illustrated in the figure) that are located adjacent the first edge 32. Where the apparatus 12 is incorporated in a portable device such as a mobile cellular telephone and the first edge 32 is located at the perimeter of the device, the portable device may efficiently inductively couple with other coupling members.

FIG. 5 illustrates a flow diagram of a method of manufacturing an apparatus 12 according to various embodiments of the invention. At block 56, the method includes providing a ground member 22 including an edge 32. At block 58, the method includes providing a near field coupling member 30 and arranging the near field coupling member 30 on the ground member 22. In various embodiments, the near field coupling member 30 may be integral with the ground member 22 and block 58 may include forming the near field coupling member 30 out of the ground member 22 (for example, by cutting out sections of the ground member 22).

At block 60, the method optionally includes providing one or more decoupling members 48 between the near field coupling member 30 and the ground member 22 and/or one or more antennas 18. For example, at block 60, decoupling capacitors may be connected between the near field coupling member 30 and the ground member 30.

The blocks illustrated in the FIG. 5 may represent steps in a method and/or sections of code in a computer program. For example, a processor may be configured to read and execute the computer program in a memory to control machinery to perform the method. The illustration of a particular order to the blocks does not necessarily imply that there is a required or preferred order for the blocks and the order and arrangement of the block may be varied. Furthermore, it may be possible for some blocks to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

I/We claim:

1. An apparatus comprising:
a ground member including an edge;
a near field coupling member configured to electromagnetically couple with other coupling members external to the apparatus, and being configured to receive signals from and/or provide signals to radio frequency circuitry, the near field coupling member including one or more loops defining an aperture and at least a first portion of the one or more loops being positioned adjacent or at the edge of the ground member, the near field coupling member being configured to receive one or more antennas within the aperture of the one or more loops, and further comprising one or more decoupling members configured to reduce interference between the near field coupling member and the one or more antennas.

2. An apparatus as claimed in claim 1, wherein the first portion of the one or more loops is positioned outside of the edge of the ground member and is separated from the edge by a first gap.

3. (canceled)

4. An apparatus as claimed in claim 1, wherein the near field coupling member is configured to operate in a first frequency band and the one or more antennas are configured to operate in at least a second frequency band.

5. An apparatus as claimed in claim 1, wherein the one or more decoupling members includes one or more reactive components connected between the near field coupling member and the ground member, the one or more reactive components having an impedance at the first frequency band greater than the impedance at the second frequency band.

6. An apparatus as claimed in claim 4, wherein a second portion of the one or more loops overlays the ground member and includes a part separated from the ground member by a second gap, the second gap being selected to form a capacitor with the ground member having an impedance at the first frequency band greater than the impedance at the second frequency band

7. An apparatus as claimed in claim 1, wherein the one or more decoupling members includes ferrous material positioned between the near field coupling member and one or more of: the ground member and the one or more antennas.

8. An apparatus as claimed in claim 1, wherein no ferrous material is provided between the near field coupling member and the ground member.

9. An apparatus as claimed in claim 1, wherein the near field coupling member is non-planar.

10. An apparatus as claimed in claim 1, wherein the first portion of the one or more loops is integral with the ground member.

11. A module comprising an apparatus as claimed in claim 1.

12. An electronic device comprising an apparatus as claimed in claim 1.

13. A method comprising:
providing a ground member including an edge; and
providing a near field coupling member configured to electromagnetically couple with other coupling members external to the apparatus, and being configured to receive signals from and/or provide signals to radio frequency circuitry, the near field coupling member including one or more loops defining an aperture and at least a first portion of the one or more loops being positioned adjacent or at the edge of the ground member, the near field coupling member being configured to receive one or more antennas within the aperture of the one or more loops, and further comprising providing one or more decoupling members configured to reduce interference between the near field coupling member and the one or more antennas.

14. A method as claimed in claim 13, wherein the first portion of the one or more loops is positioned outside of the edge of the ground member and is separated from the edge by a first gap.

15. (canceled)

16. A method as claimed in claim 13, wherein the near field coupling member is configured to operate in a first frequency band and the one or more antennas are configured to operate in at least a second frequency band.

17. A method as claimed in claim 13 wherein the one or more decoupling members includes one or more reactive components connected between the near field coupling member and the ground member, the one or more reactive components having an impedance at the first frequency band greater than the impedance at the second frequency band.

18. A method as claimed in claim 16, wherein a second portion of the one or more loops overlays the ground member and includes a part separated from the ground member by a second gap, the second gap being selected to form a capacitor with the ground member having an impedance at the first frequency band greater than the impedance at the second frequency band.

19. A method as claimed in claim 13, wherein the one or more decoupling members includes ferrous material positioned between the near field coupling member and one or more of: the ground member and the one or more antennas.

20. A method as claimed in 13, wherein no ferrous material is provided between the near field coupling member and the ground member.

21. A method as claimed in any of claim 13, wherein the near field coupling member is non-planar.

22. A method as claimed in claim 13, wherein the first portion of the one or more loops is integral with the ground member.
